(19) United States
(12) Patent Application Publication
(10) Pub. No.: US 2015/0317710 A1
(43) Pub. Date: Nov. 5, 2015

(54) METHOD AND SYSTEM FOR ANONYMOUS GIFTING

(71) Applicant: KARLA HAWKINSON, MOUNT HERMON, CA (US)

(72) Inventor: KARLA HAWKINSON, MOUNT HERMON, CA (US)

(21) Appl. No.: 14/269,138

(22) Filed: May 3, 2014

(51) Int. Cl. G06Q 30/06; G06Q 50/00

(52) U.S. Cl. CPC G06Q 30/0613; G06Q 50/01

(57) ABSTRACT

A method and system for enabling selectively anonymous gifting. A gift requester may ask a trusted intermediary to post a request for a good, a set of goods, or a service, wherein the posting may or may not identify the requester. The intermediary may be identified and an approval of the gift request posting by the intermediary is implicitly or explicitly published. The giving party may also optionally choose to remain anonymous or may be identified to the intermediary, the gift requestor and/or a recipient of a requested gift. These objects may be enabled by an electronically intermediated social network, such as FACEBOOK™ social networking service, LINKEDIN™ social networking service, TWITTER™ social networking service and/or MEETUP™ social networking service.

### FIELD OF THE INVENTION

The present invention relates to electronically mediated social networks. More particularly, the present invention relates to methods of, and systems for, enabling the purchase, ordering and gifting of goods and services at least partially by means of an electronically mediated social network.

### BACKGROUND OF THE INVENTION

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

The prior art enables parties to post requests for gifts to themselves or other parties via the World Wide Web and various social networking services, such as the social networking services of FACEBOOK™, LINKEDIN™, TWITTER™ and/or MEETUP™. Yet the prior art fails to easily enable a requesting party to have a gift request validated and published by an endorsing party without risking disclosure of the requesting party's identity. The potential for wide exposure as a party asking for charity resulting from posting a request for aid on internet-based social networking service discourages many worthy and deserving persons from requesting help for themselves, their children, their parents, or other intimates.

There is therefore a long-felt need to enable a requesting party to request a gift of a good or a service by means of an electronically mediated social networking service while more effectively shielding the requesting party's identity such that the requestor does not have to bear any shame of asking for charity.

### SUMMARY AND OBJECTS OF THE INVENTION

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Towards the object of enabling anonymous gift requesting, and other objects that are made obvious in light of the present disclosure, system and method are provided that enable a computer-implemented method (1.) creating and/or receiving an electronic notice of a gift request from a first party for a good or service for dissemination to a social network and/or endorsing party; (2.) generating an endorsed request, the endorsed request identifying the good or service, or generic description thereof, and an endorsing party without identifying the first party; (3.) publishing the endorsed request within a social network service, a community, or the general public; (4.) enabling authorization of a fulfillment of the endorsed request by a third party, whereby a delivery of the good or service is authorized by the third party while not requiring a disclosure of the identity of the first party to the third party.

### BRIEF DESCRIPTION OF THE FIGURES

These, and further features of the invention, may be better understood with reference to the accompanying specification and drawings depicting the preferred embodiment, in which:

FIG. 1 is a network diagram of elements of an exemplary network for anonymous gifting;

FIG. 1A is a block diagram of an exemplary network server;

FIG. 1B is a block diagram of software contained on a network server;

FIG. 1C is a block diagram of an exemplary intermediary, proxy system;

FIG. 1D is a block diagram of software contained on an intermediary, proxy system;

FIG. 1E is a block diagram of an exemplary requestor system;

FIG. 1F is a block diagram of software contained on a requestor system;

FIG. 1G is a block diagram of an exemplary giver system;

FIG. 1H is a block diagram of software contained on a giver system;

FIG. 2 is a flow chart depicting a possible scenario of the anonymous gifting processes by the invented system server in processing anonymous gifts among a plurality of the participants of the system network of FIG. 1;

FIG. 3 is a flow chart depicting requestor actions within a possible scenario of the anonymous gifting process where requestor of the network of FIG. 1 requests a specific product gift;

FIG. 4 is a flow chart depicting requestor actions within another possible scenario of the anonymous gifting process where requestor requests a generic product gift by means of the network of FIG. 1;

FIG. 5 is a flow chart depicting intermediary actions within a possible scenario of the anonymous gifting process of the network of FIG. 1 wherein an intermediary receives and shares a specific gift request with plurality of givers;

FIG. 6 is a flow chart depicting intermediary actions of the network of FIG. 1 within another possible scenario of the anonymous gifting process where an intermediary receives a generic request then first selects a product, adds a product identifier to the request, and shares the gift request with plurality of givers;

FIG. 7 is a flow chart depicting giver actions within a possible scenario of the anonymous gifting process of the network of FIG. 1 wherein a giver first receives the gift request and then logs into the system server to fund the product specified in the received request;

FIG. 8 is a flow chart depicting giver actions within a possible scenario of the invented anonymous gifting process wherein a giver first logs into the system server and then searches and reviews all available requests to find and select an appealing request so that the giver can fund or otherwise fulfill one or more requests;

FIG. 9 is a block diagram depicting requestor characteristics that can be used within a possible scenario of anonymous gifting processes by givers in searching and finding an appealing request to fund;

FIG. 10 is a software flowchart of actions of the requestor system of FIG. 1 in performing optional aspects of another alternate preferred embodiment of the invented method;

FIG. 11 is a software flowchart of actions of the server of FIG. 1 in performing optional aspects of the alternate embodiment of the invented method of FIG. 10;

FIG. 12 is a software flowchart of actions of one of the intermediary servers of FIG. 1 in performing optional aspects of the alternate embodiment of the invented method of FIG. 10;

FIG. 13 is a software flowchart of actions of one of the giver systems of FIG. 1 in performing optional aspects of the alternate embodiment of the invented method of FIG. 10;

FIGS. 14A through 14I are block diagrams of software records and electronic messages that are applied in the alternate embodiment of the invented method of FIG. 10 through FIG. 13.

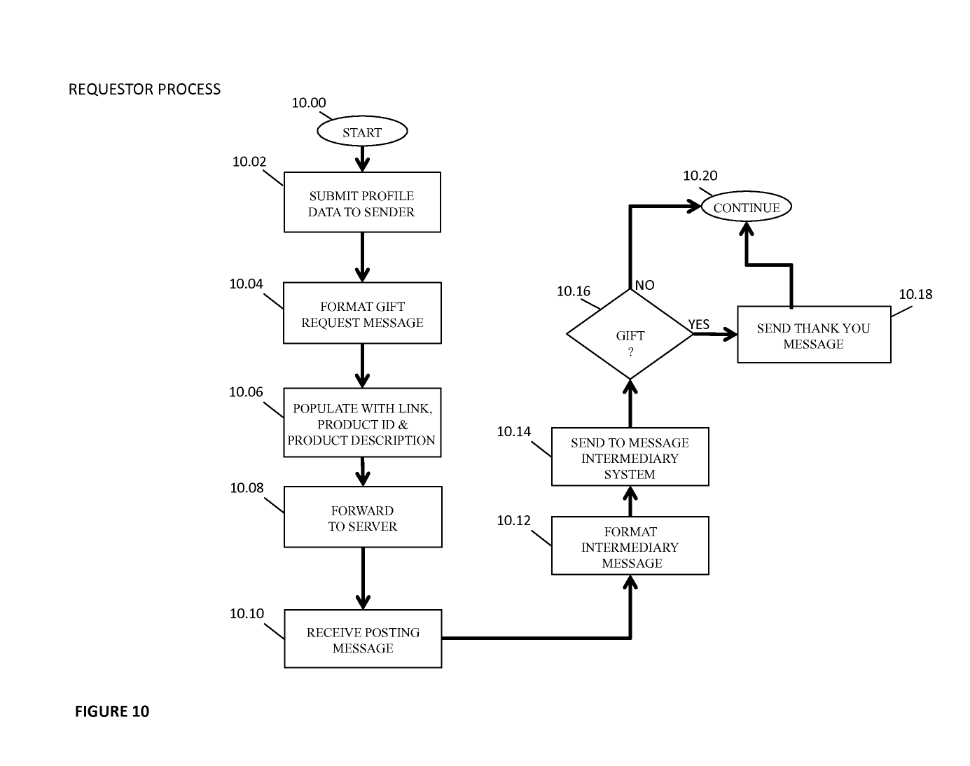

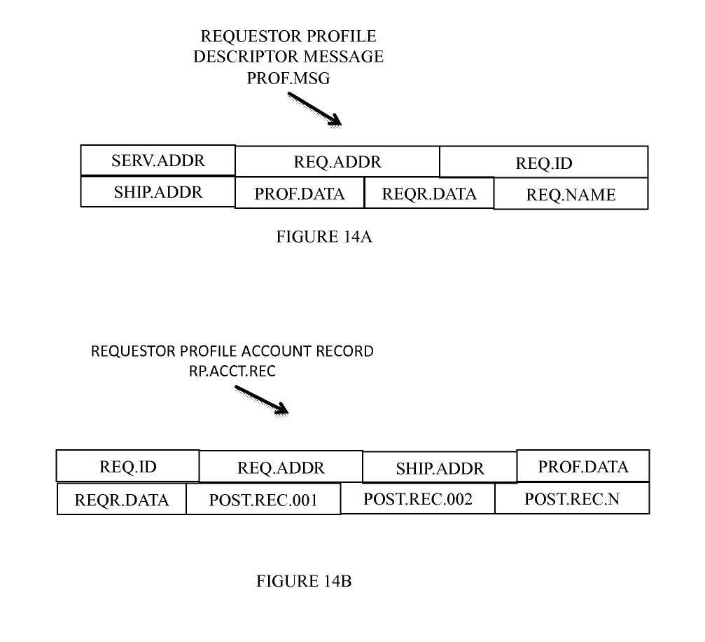

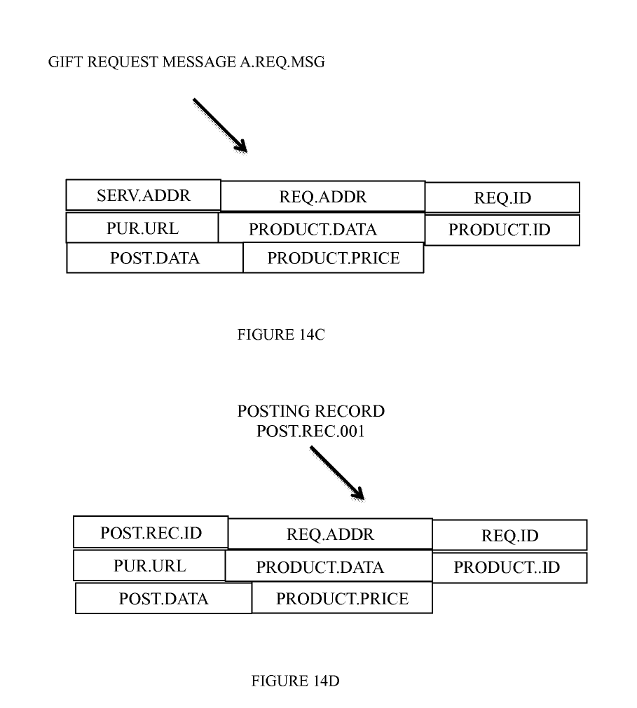

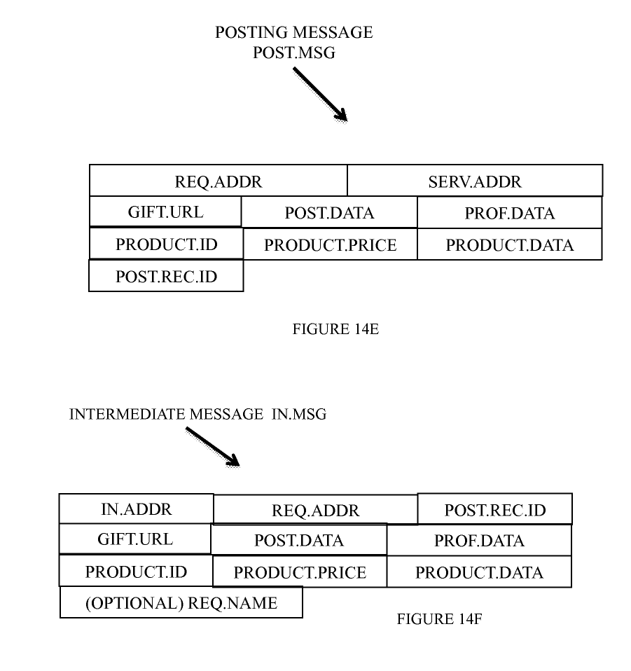

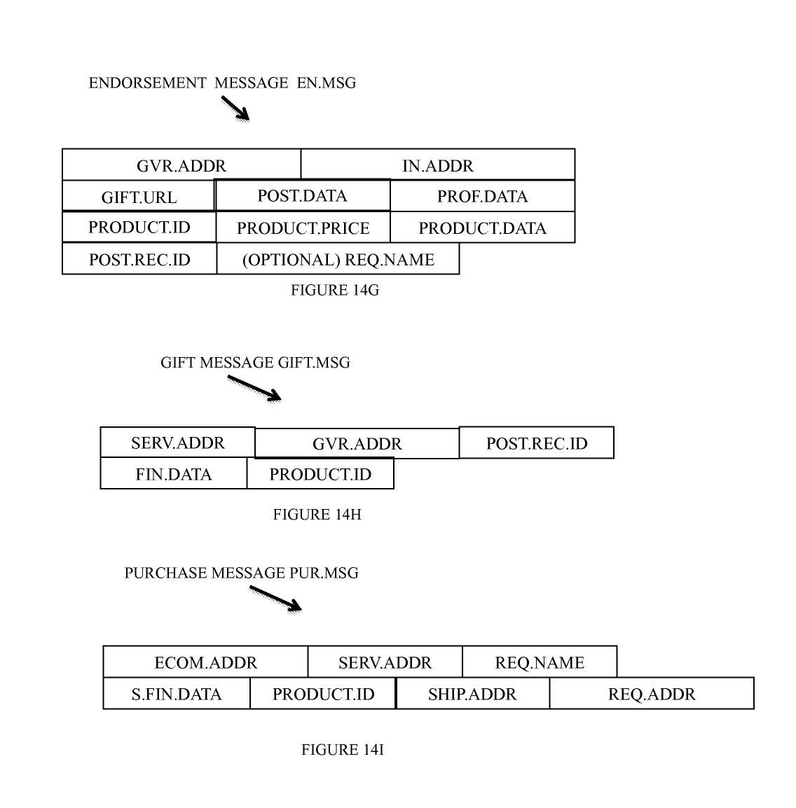

Referring now generally to the Figures and particularly to FIG. 14A, FIG. 14A is a block diagram of an exemplary first requestor profile descriptor message of step 10.02 of FIG. 10;

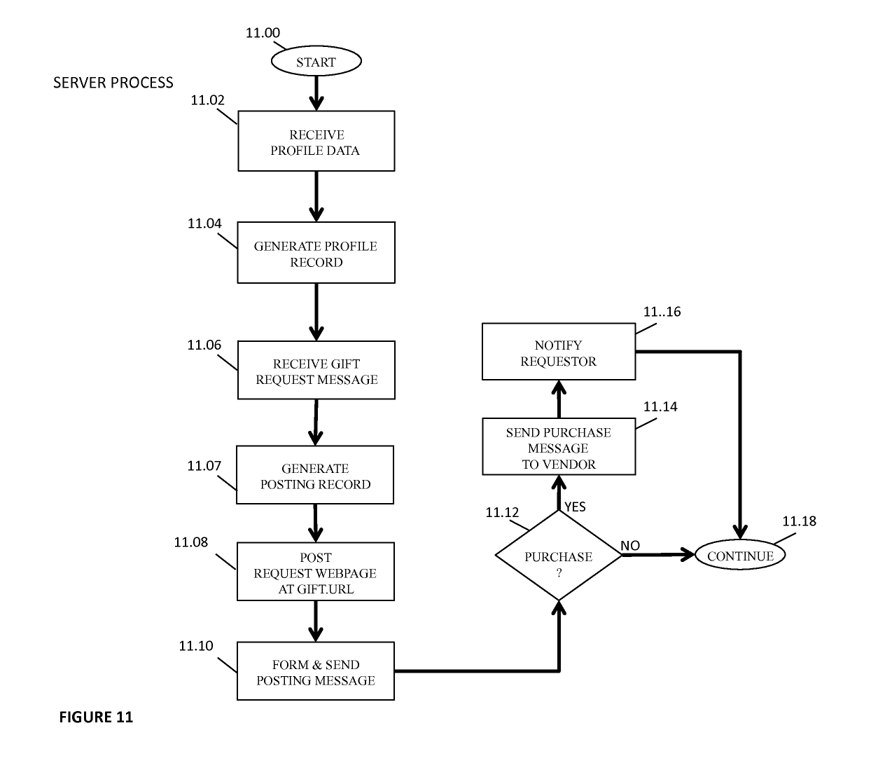

Referring now generally to the Figures and particularly to FIG. 14B, FIG. 14B is a block diagram of an exemplary first profile account record of step 11.04 of FIG. 11;

Referring now generally to the Figures and particularly to FIG. 14C, FIG. 14C is a block diagram of an exemplary first alternate gift request message step 10.08 of FIG. 10;

Referring now generally to the Figures and particularly to FIG. 14D, FIG. 14D is a block diagram of an exemplary first posting record of step 11.07 of FIG. 11;

Referring now generally to the Figures and particularly to FIG. 14E, FIG. 14E is a block diagram of an first exemplary first posting message of step 11.10 of Figure;

Referring now generally to the Figures and particularly to FIG. 14F, FIG. 14 F is a block diagram of an exemplary first intermediate message of step 10.14 of FIG. 10;

Referring now generally to the Figures and particularly to FIG. 14G, FIG. 14G is a block diagram of an exemplary first endorsement message of step 12.06 of Figure;

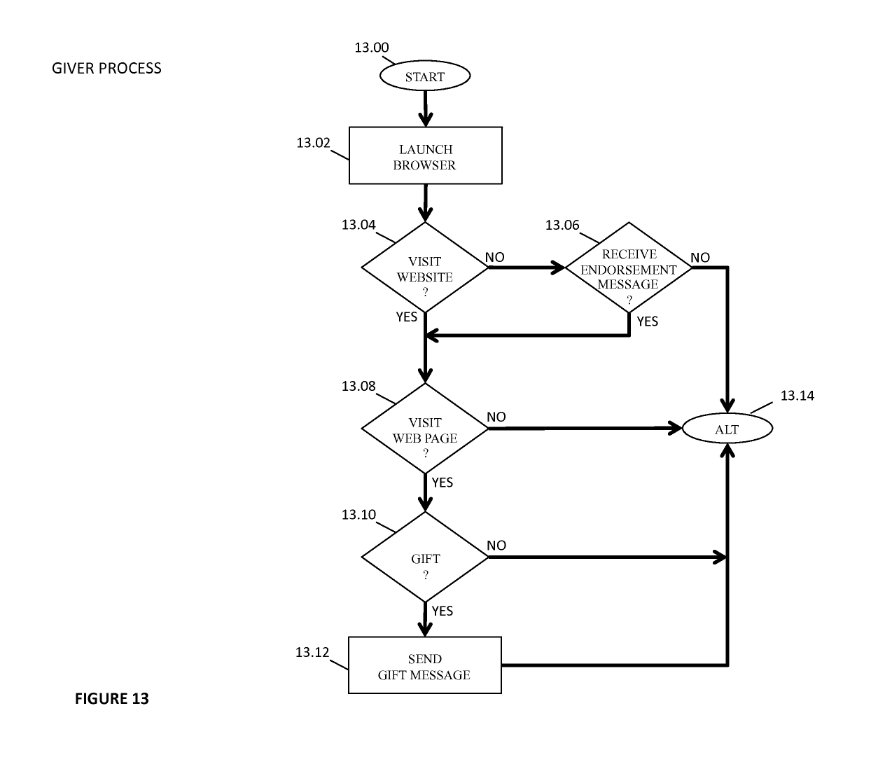

Referring now generally to the Figures and particularly to FIG. 14H, FIG. 14H is a block diagram of an exemplary alternate first gift message of step 13.12 of FIG. 13; and

Referring now generally to the Figures and particularly to FIG. 14I, FIG. 14I is a block diagram of an exemplary first purchase message of step 11.14 FIG. 11.

### DETAILED DESCRIPTION

It is to be understood that this invention is not limited to particular aspects of the present invention described, as such may, of course, vary. It is also to be understood that the terminology used herein is for the purpose of describing particular aspects only, and is not intended to be limiting, since the scope of the present invention will be limited only by the appended claims.

Methods recited herein may be carried out in any order of the recited events which is logically possible, as well as the recited order of events.

Where a range of values is provided herein, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, the methods and materials are now described.

It must be noted that as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

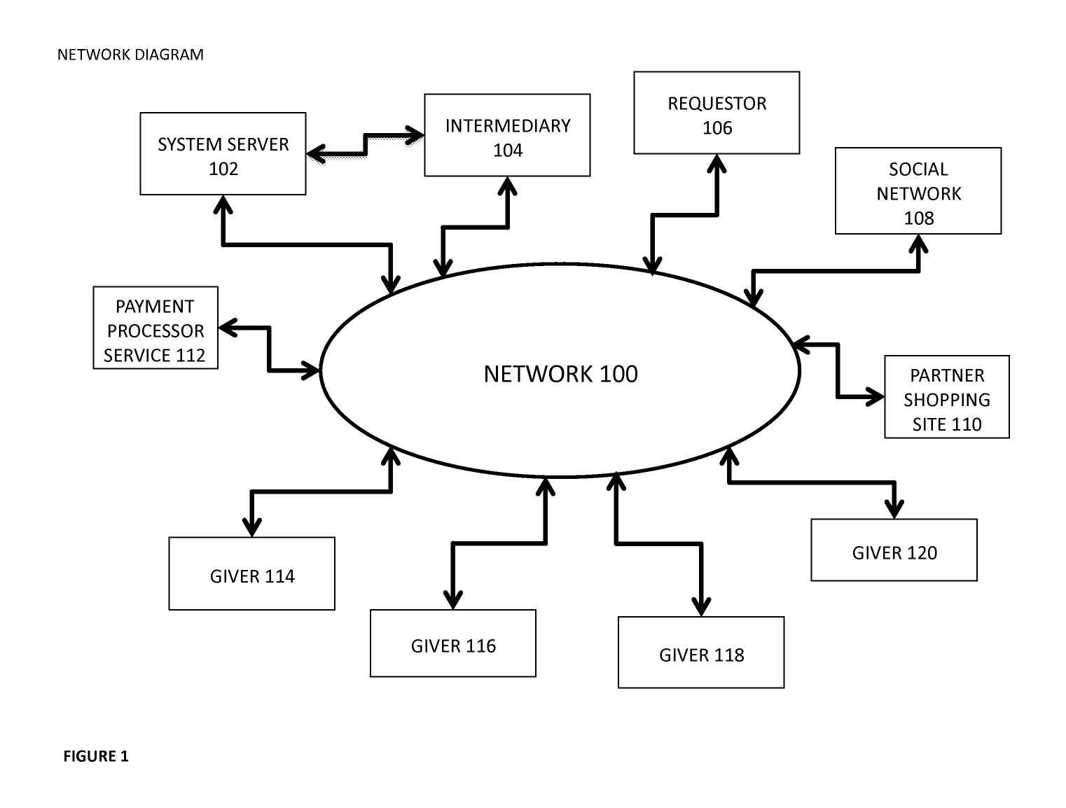

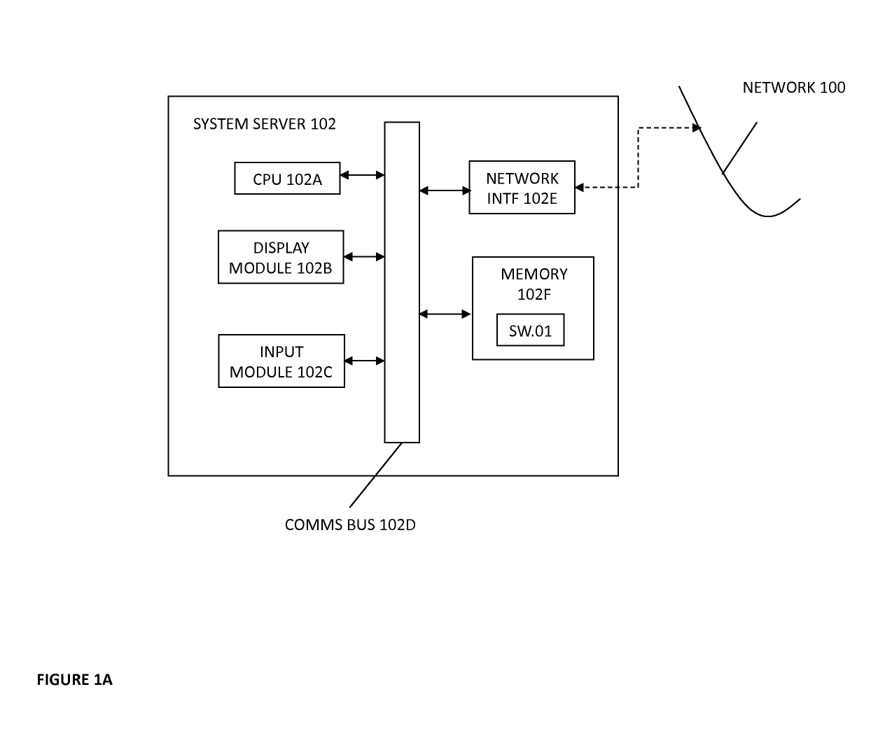

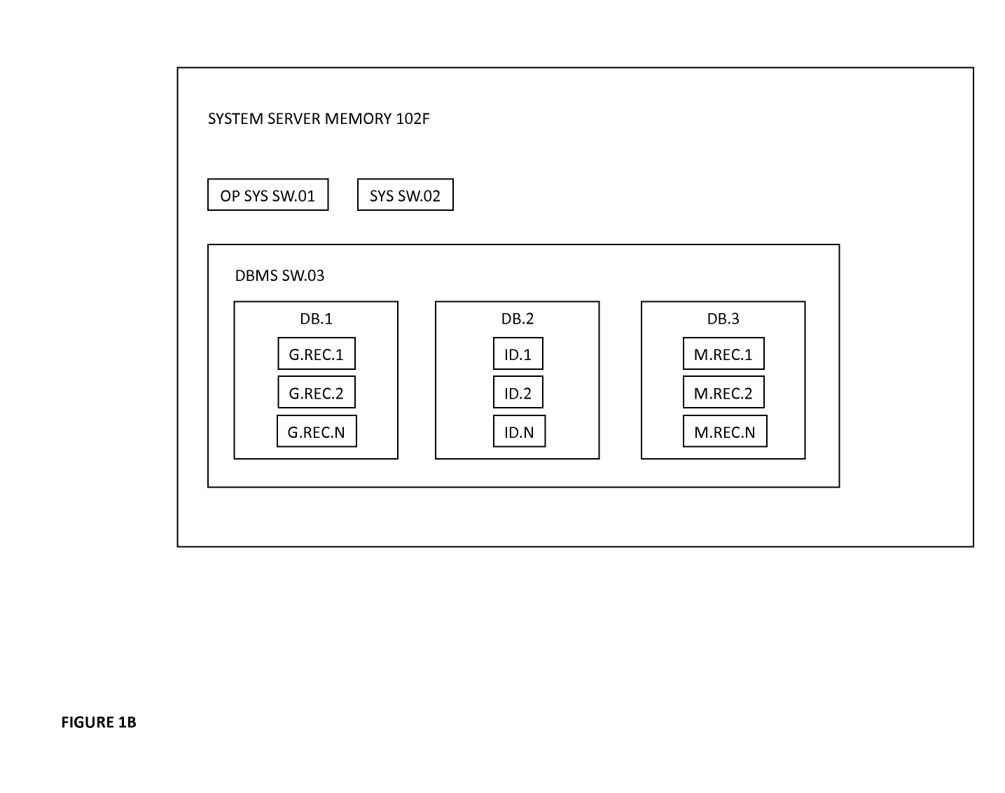

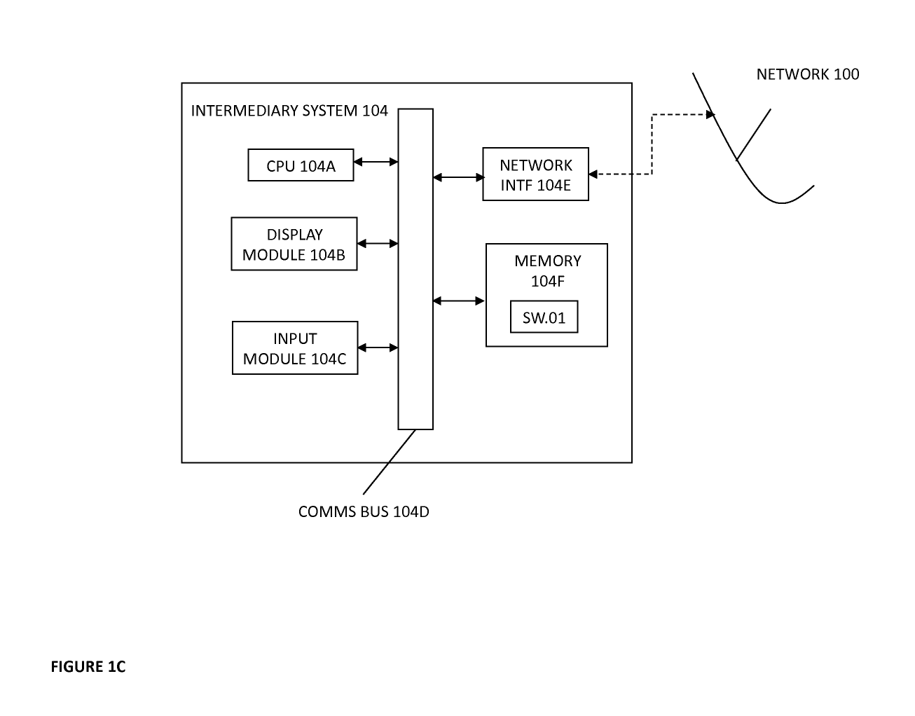

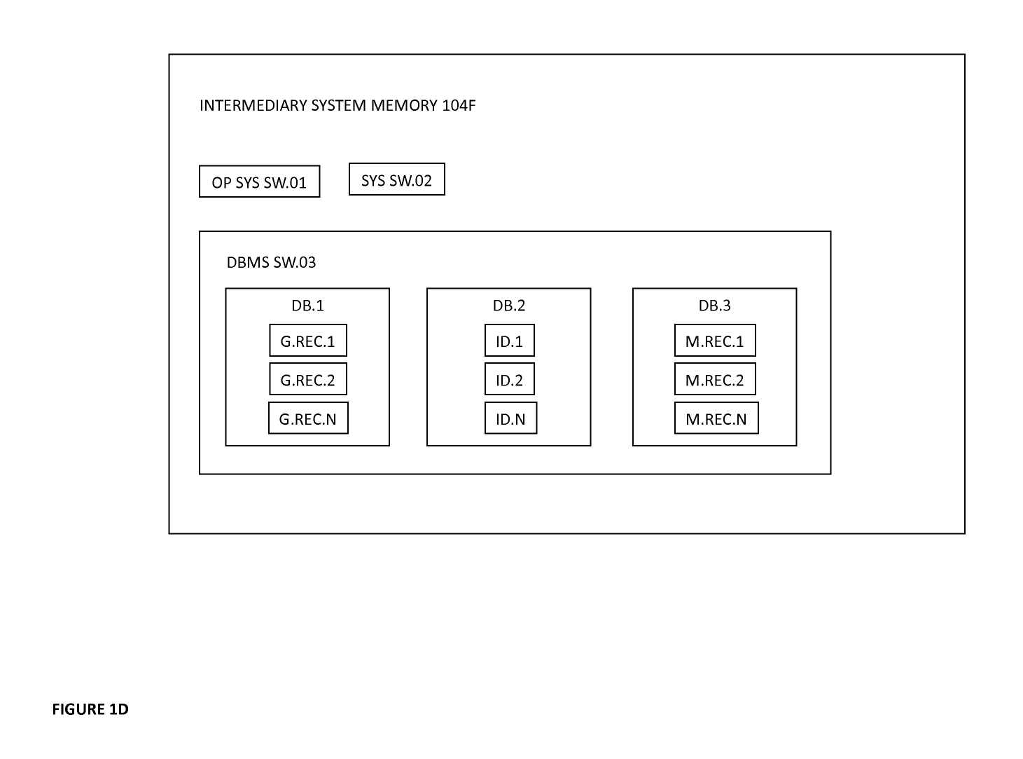

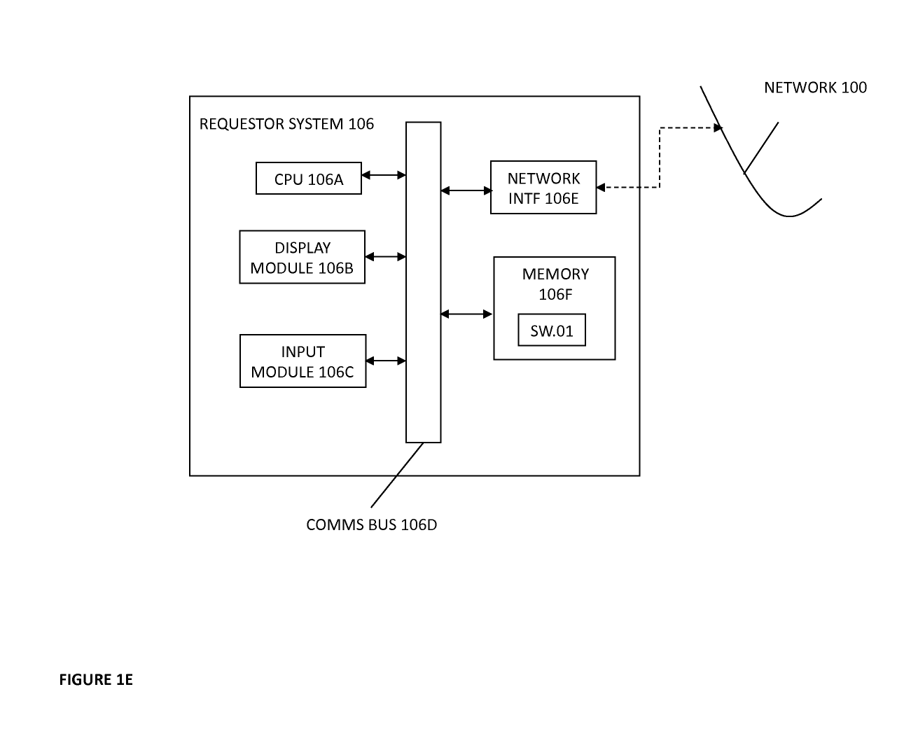

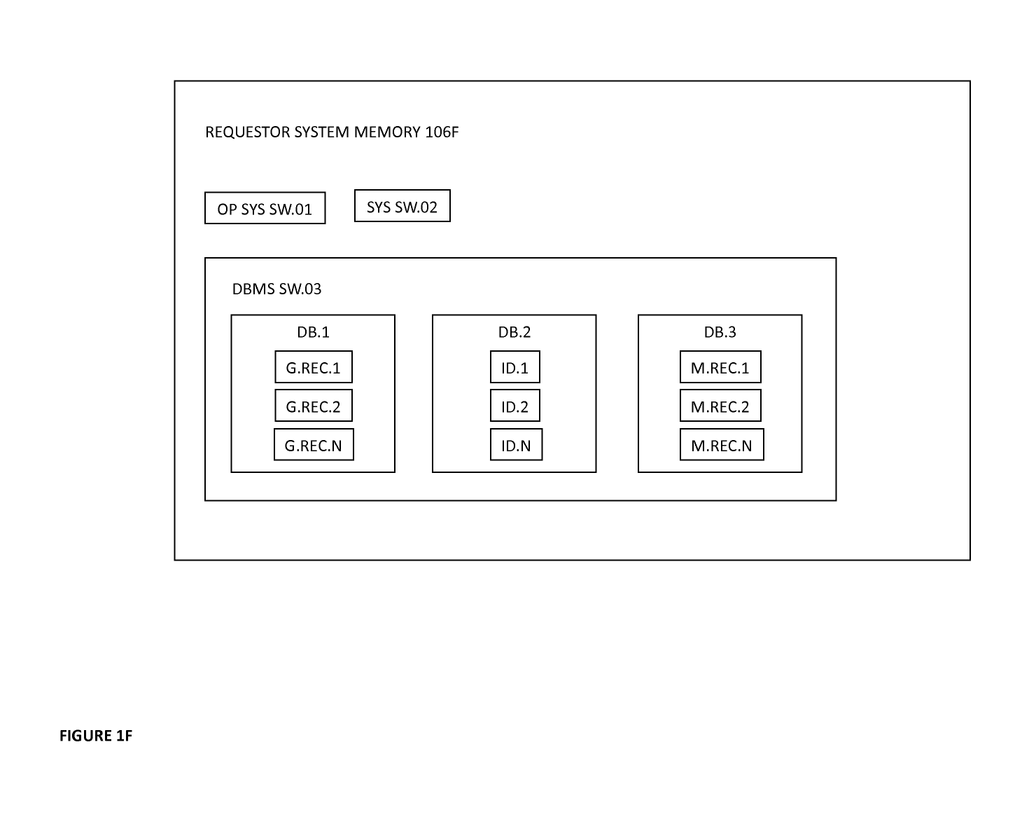

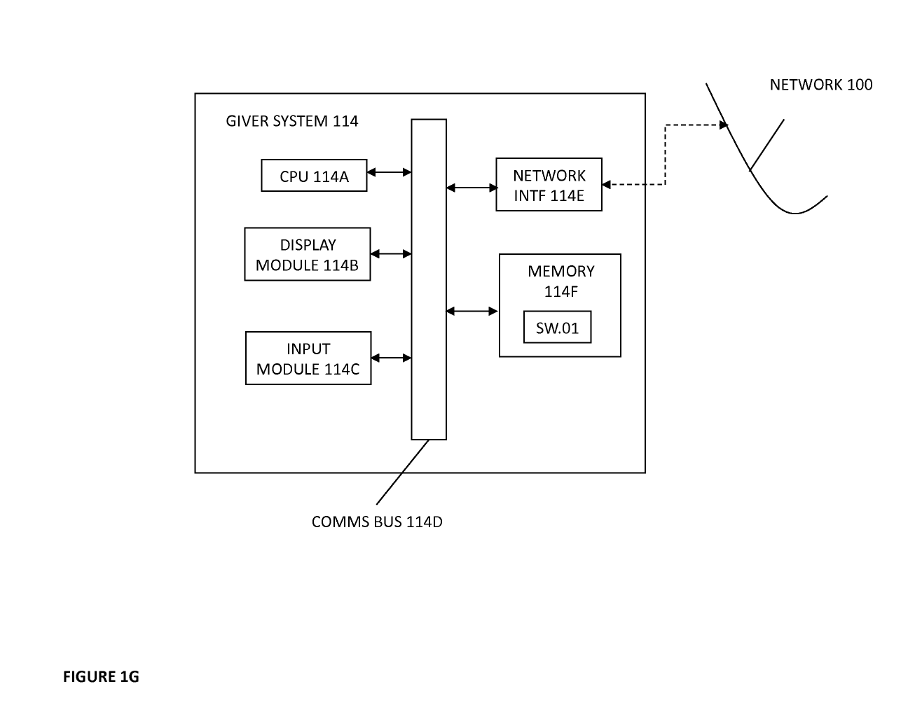

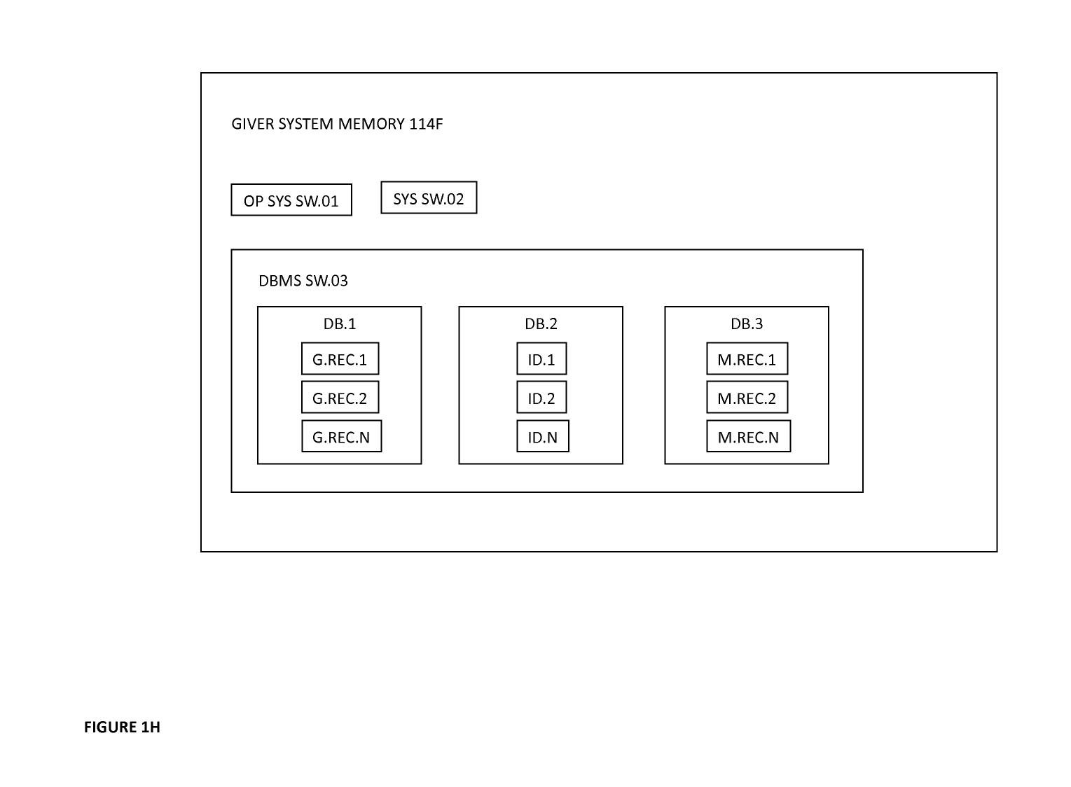

Referring now generally to the Figures and particularly to FIG. 1, FIG. 1 is a network diagram of elements of an exemplary network 100 (hereinafter, “network” 100) adapted for anonymous gifting, and includes: (1.) a system server 102 that consists of a processing system that processes anonymous gift requests and gift request fulfillments among certain participants 102-106 & 114-120 of the system network 100 with processing instructions stored in memory for performing the actions and/or steps described herein, examples of a system server 102 may include one or more servers, personal computers, mobile computers, and/or mobile devices, and other computing devices; (2) a human intermediary operating an intermediary participant system 104 (hereinafter, “intermediary” 104), examples of an intermediary 104 may include one or more servers, personal computers, mobile computers, and/or mobile devices, and other computing devices; (3) a human requestor operating a requestor participant system 106 (hereinafter, “requestor” 106), examples of a requestor 106 may include one or more servers, personal computers, mobile computers, and/or mobile devices, and other computing devices; (4) a social network server 108 for connecting participants of the network 100, examples of a social network server 108 may include one or more servers, personal computers, mobile computers, and/or mobile devices, and other computing devices; (5) a partner shopping server 110 adapted for selecting gifts, placing purchase orders and shipping gifts to a requestor, examples of a shopping server 110 may include one or more servers, personal computers, mobile computers, and/or mobile devices, and other computing devices; (6) a plurality of human giver participants operating several giver systems 114-120 (hereinafter, “givers” 114-120), examples of givers 114-120 may include one or more servers, personal computers, mobile computers, and/or mobile devices, and other computing devices; and (7) a payment processing server 112.

One or more systems 104-120 or servers 102 may be or comprise a bundled hardware and software informational technology system including but not limited to (a.) a network-communications enabled THINKSTATION WORKSTATION™ notebook computer marketed by Lenovo, Inc. of Morrisville, N.C.; (b.) a NIVEUS 5200 computer workstation marketed by Penguin Computing of Fremont, Calif. and running a LINUX™ operating system or a UNIX™ operating system; (c.) a network-communications enabled personal computer configured for running WINDOWS XP™, VISTA™ or WINDOWS 7™ operating system marketed by Microsoft Corporation of Redmond, Wash.; (d.) a MACBOOK PRO™ personal computer as marketed by Apple, Inc. of Cupertino, Calif.; (e.) an IPAD™ tablet computer as marketed by Apple, Inc. of Cupertino, Calif.; (f.) an IPHONE™ cellular telephone as marketed by Apple, Inc. of Cupertino, Calif.; (g.) an HTC TITAN II™ cellular telephone as marketed by AT&T, Inc. of Dallas, Tex. and running a WINDOWS 7™ operating system as marketed by Microsoft Corporation of Redmond, Wash.; (h.) a GALAXY NEXUS™ smart phone as marketed by Samsung Group of Seoul, Republic of Korea or and running an ANDROID™; (i.) a TOUGHPAD™ tablet computer as marketed by Panasonic Corporation of Kadoma, Osaka, Japan and running an ANDROID™ operating system as marketed by Google, Inc. of Mountain View, Calif.; or (j.) other suitable mobile electronic device, wireless communications device, computational system or electronic communications device known in the art.

Referring now generally to the Figures and particularly to FIG. 1A, FIG. 1A is an exemplary network server. A system server 102 used for processing incoming requests and forwarding those requests on to givers 114-118 or intermediary proxy servers 104 would include several components. These components would include a server CPU 102A, a server display 102B, a server user input module 102C, a server network interface 102E, a server system memory 102F, and a server bi-directional communications bus 102D that communicatively couples the server CPU 102A, the server display 102B, the server user input module 102C, the server network interface 102E, and the server system memory 102F.

Referring now generally to the Figures and particularly to FIG. 1B, FIG. 1B is a block diagram of software contained on the system server 102. Stored in system memory 102F, would be at least an operating system SW.01, system software SW.02, and one or more database management systems (DBMS) SW.03. The DBMS SW.03 may be selected from prior art database management systems including, but not limited to, Objectivity/DB 10™ marketed by Objectivity, Inc. of Mountain View, Calif.; a Database 2™, also known as DB2™, relational database management system as marketed by IBM Corporation of Armonk, N.Y.; an Advantage Database Server™ relational database management system as marketed by Sybase, Inc. of Dublin, Calif., or other suitable database management software known in the art. Within the DBMS SW.03, there would be multiple databases (DB.01-DB.03) each having records G.REC, ID, and M-REC used for managing the anonymous gifting system. These records would be shared with other entities in the network.

Referring now generally to the Figures and particularly to FIG. 1C, FIG. 1C is a block diagram of an exemplary proxy intermediary system 104. An intermediary 104 used for anonymizing requests sent to the network 100 would include several components. These components would include an intermediary CPU 104A, an intermediary display 104B, an intermediary user input module 104C, an intermediary network interface 104E, an intermediary system memory 104F, and an intermediary bi-directional communications bus 104D that communicatively couples the intermediary CPU 104A, the intermediary display 104B, the intermediary user input module 104C, the intermediary network interface 104E, and the intermediary system memory 104F.

Referring now generally to the Figures and particularly to FIG. 1D, FIG. 1D is a block diagram of software contained on an intermediary proxy 104. Stored in system memory 104F, would be at least an operating system SW.01, system software SW.02, and one or more database management systems (DBMS) SW.03. The DBMS SW.03 may be selected from prior art database management systems including, but not limited to, Objectivity/DB 10™ marketed by Objectivity, Inc. of Mountain View, Calif.; a Database 2™, also known as DB2™, relational database management system as marketed by IBM Corporation of Armonk, N.Y.; an Advantage Database Server™ relational database management system as marketed by Sybase, Inc. of Dublin, Calif., or other suitable database management software known in the art. Within the DBMS SW.03, there would be multiple databases (DB.01-DB.03) each having records G.REC, ID, and M-REC used for managing the anonymous gifting system. These records would be shared with other entities in the network. These records are the same as those contained on the system server 102.

Referring now generally to the Figures and particularly to FIG. 1E, FIG. 1E is a block diagram of an exemplary requestor system 106. A requestor system 106 used for making requests of goods or services to the system server 102 may include several components. These components include a requestor CPU 106A, a requestor display 106B, a requestor user input module 106C, a requestor network interface 106E, a requestor system memory 106F, and a requestor bi-directional communications bus 106D that communicatively couples the requestor CPU 106A, the requestor display 106B, the requestor user input module 106C, the requestor network interface 106E, and the requestor system memory 106F.

Referring now generally to the Figures and particularly to FIG. 1F, FIG. 1F is a block diagram of software contained on a requestor system 106. Stored in system memory 106F, would be at least an operating system SW.01, system software SW.02, and one or more database management systems (DBMS) SW.03. The DBMS SW.03 may be selected from prior art database management systems including, but not limited to, Objectivity/DB 10™ marketed by Objectivity, Inc. of Mountain View, Calif.; a Database 2™, also known as DB2™, relational database management system as marketed by IBM Corporation of Armonk, N.Y.; an Advantage Database Server™ relational database management system as marketed by Sybase, Inc. of Dublin, Calif., or other suitable database management software known in the art. Within the DBMS SW.03, there would be multiple databases (DB.01-DB.03) each having records G.REC, ID, and M-REC used for managing the anonymous gifting system. These records would be shared with other entities in the network. These records are the same as those contained on the system server 102.

Referring now generally to the Figures and particularly to FIG. 1G, FIG. 1G is a block diagram of an exemplary giver system 114. A giver system 114 (hereinafter, “giver” 114) used for purchasing goods or services on behalf of a requester 106 would include several components. These components include a giver CPU 114A, a giver display 114B, a giver user input module 114C, a giver network interface 114E, a giver system memory 114F, and a giver bi-directional communications bus 114D that communicatively couples the giver CPU 114A, the giver display 114B, the giver user input module 114C, the giver network interface 114E, and the giver system memory 114F. It is understood that each additional giver system 116-120 may includes one or all of the components 114A-114F of the exemplary giver 114.

Referring now generally to the Figures and particularly to FIG. 1H, FIG. 1H is a block diagram of software contained on a giver 114. Stored in system memory 114F, would be at least an operating system SW.01, system software SW.02, and one or more database management systems (DBMS) SW.03. The DBMS SW.03 may be selected from prior art database management systems including, but not limited to, Objectivity/DB 10™ marketed by Objectivity, Inc. of Mountain View, Calif.; a Database 2™, also known as DB2™, relational database management system as marketed by IBM Corporation of Armonk, N.Y.; an Advantage Database Server™ relational database management system as marketed by Sybase, Inc. of Dublin, Calif., or other suitable database management software known in the art. Within the DBMS SW.03, there would be multiple databases (DB.01-DB.03) each having records G.REC, ID, and M-REC used for managing the anonymous gifting system. These records would be shared with other entities in the network. These records are the same as those contained on the system server 102.

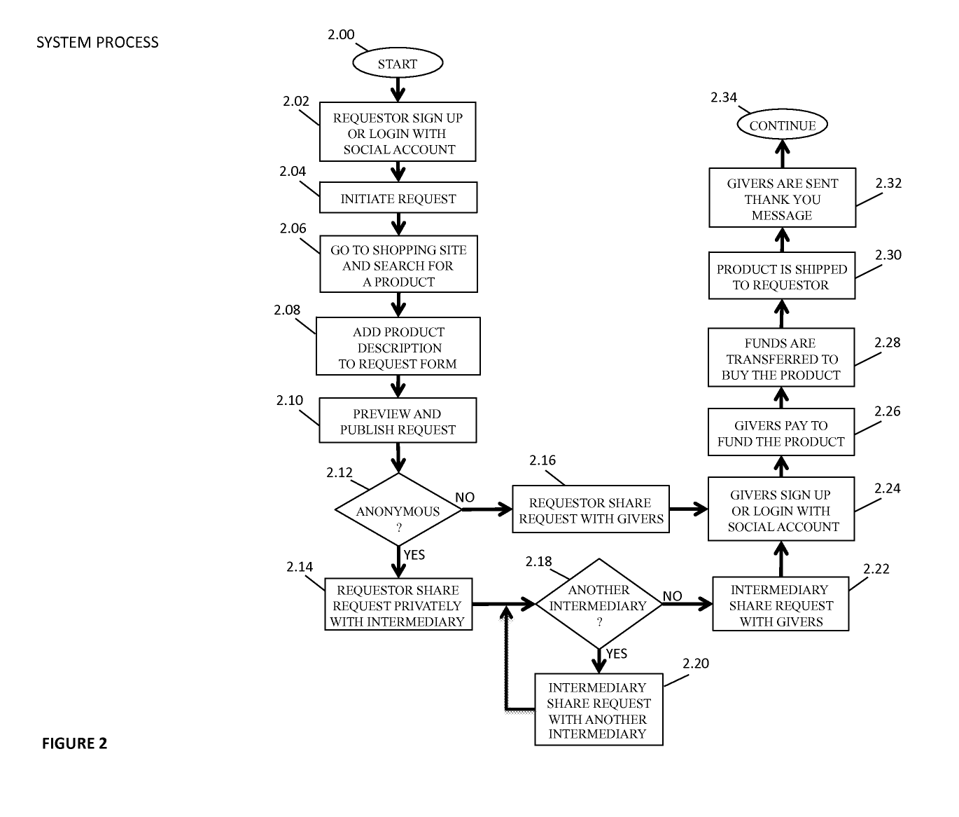

Referring now generally to the Figures and particularly to FIG. 2, FIG. 2 is a flow chart depicting a possible scenario of the anonymous gifting processes by the invented system server 102 wherein the system server 102 consists of a processing system that processes anonymous gift requests and gift request fulfillment among certain participants 102-106 & 114-120 of the system network 100 (hereinafter, “the network” 100) with processing instructions stored in memory for performing the actions and/or steps described herein.

The system server 102 accepts the login of a requestor 106, in step 2.02, optionally using the requestor's first social account login information of an established third party identity service (hereinafter “first social account authentication”) for authenticating the requestor 106, and optionally allowing the requestor 106 to create a new set of authenticated login information assigning the requestor 106 to a new account on the system server 102. After the requestor 106 has logged into the system server 102, the system server 102 allows the requestor 106 to initiate a new request for an anonymous gift in step 2.04 and, in step 2.06, directs the requestor to the shopping server 110, to search for a product to be used as a gift. At the same time the system server 102 displays a part of the request form wherein the requestor 106 can enter a link to a webpage related to a product and product request description. Once the product request information has been added by the requestor 106, in step 2.10 the system server 102 opens a preview of the completed request and after receiving a confirmation from the requestor 106, publishes the request, request description, and imported product description within the system network 100.

The system server 102, in step 2.12, receives an input from the requestor 106 to whether the gift request will be shared directly with a potential plurality of givers 114-120, leading the requestor 106 to share the request with the plurality of givers 114-120 in step 2.16 while displaying publicly the requestor 106 identity, or if the gift request will be shared with an intermediary participant 104, leading the requestor 106 to share the gift request with an intermediary participant 104 in step 2.14 while preserving the anonymity of the requestor 106. When the intermediary 104 has been chosen by the requestor 106, the system server 102 provides optional choices in steps 2.18 and 2.20 to share the request with another intermediary 104. Once the intermediary 104 has received shared request, the system server 102 allows the intermediary 104 to share the request with the plurality of givers 114-120 in step 2.22.

Once the givers 114-120 have received the request either in 2.16 or 2.22 steps, the system server 102 in step 2.24 allow the givers 114-120 to sign up or log in with their second social accounts authentication. Once the givers 114-120 are logged in, the system server 102 assists the givers 114-120 with paying to fund the requested product purchase in step 2.26. After receiving a total payment validation, the system server 102 transfers the funds to buy the product in step 2.28 and, in step 2.30, assists with shipping the product by the partner shopping server 110 to a postal address associated with the requestor 106. In step 2.32 system server 102 communicates with givers 114-120 with a gratitude notification for the payment of the product and in step 2.34 the system server 102 continues to its next operation.

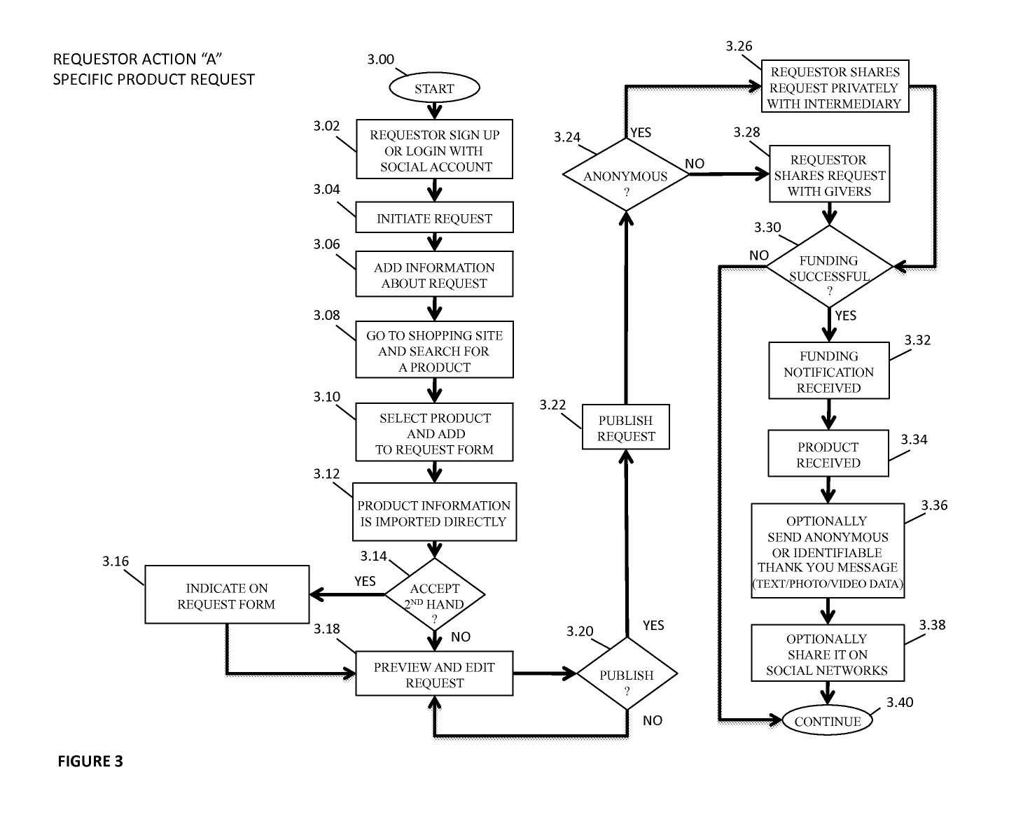

Referring now generally to the Figures and particularly to FIG. 3, FIG. 3 is a flow chart depicting actions by the requestor 106 made within a possible scenario of the anonymous gifting process wherein the requestor 106 requests a specific product gift.

The requestor 106 signs up or logs into the system server 102 using first social account authentication in step 3.02 and proceeds to initiate a gift request in step 3.04. The requestor 106 adds information about the request to the request form in step 3.06, and in step 3.08 the requestor 106 is directed to the partner shopping server 110 to search for a product or set of products to request as a gift. In step 3.10 the requestor 106 selects the desired product or products and adds information related to their need for desired product to the request form. Product details will be imported directly by the server system 102 to the request form in step 3.12. The requestor 106 may optionally indicate whether or not previously used products may be offered in place of new products to fulfill the request in step 3.14, if used products are accepted by the requestor 106 this is noted in the request form in step 3.16.

In step 3.18 the requestor 106 previews the complete request as intended for publication and is allowed to edit any inputted information in the request form. If the preview of the request is satisfactory, the requestor 106 selects to publish the request publicly in step 3.20, publishing it in step 3.22. Otherwise the requestor 106 goes back to step 3.18 to edit and preview the request until the requestor 106 is satisfied with the revision of the request. At this point the requestor can select the option to be anonymous. Once the request is published, the requestor 106, in step 3.24, decides whether to remain anonymous, then either shares the request privately with an intermediary 104 in step 3.26, or alternatively shares the request publicly with the givers 114-120 in step 3.28.

Once the system server 102 in step 3.28 determines that givers 114-120 have funded the request, the requestor 106 receives notification of the successful funding of the request in step 3.32. The product or products requested are purchased and shipped to the requestor 106 by the partner shopping site 110, and the requestor 106 receives the product or products in step 3.34. In step 3.36 the requestor 106 may optionally send either an anonymous or a self-identifying gratitude notification is mediated by the method of the present invention so that one or more givers may remain anonymous to requestor 114-120 that participated in funding the request. The gratitude notification may include photographs or a video of the received product or products in use. In step 3.38 the requestor 106 may choose to share a gratitude notification on the social network 108, and in step 3.40 the requestor 106 continues on to other tasks.

If the system server 102 in step 3.30 determines that funding was not successful, for example if a predetermined amount of time has passed since the initial request was made and the funding goal was not reached, the system continues on to other tasks in step 3.40.

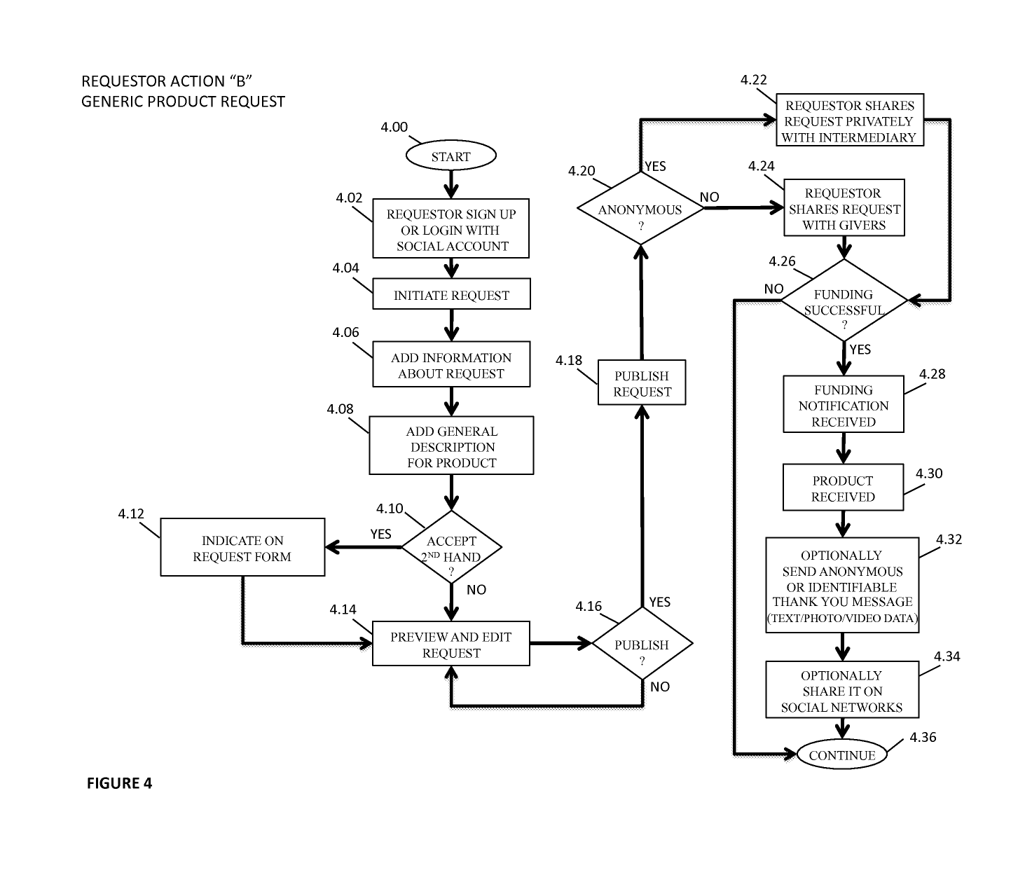

Referring now generally to the Figures and particularly to FIG. 4, FIG. 4 is a flow chart depicting possible actions taken by the requestor 106 within another possible scenario of the anonymous gifting process wherein the requestor 106 requests a generic product gift.

The requestor 106 signs up or logs into the system server 102 using a first social account authentication in step 4.02 and proceeds to initiate a gift request in step 4.04. The requestor 106 adds information about the request to the request form in step 4.06 and in step 4.08 the requestor 106 adds a general product request description to the request form without specifying unique products. The requestor 106 may optionally indicate whether or not previously used products may be offered in place of new products to fulfill the request in step 4.10, if used products are acceptable to the requestor 106 this is noted in the request form in step 4.12.

Then in step 4.14 the requestor 106 previews the complete request as intended for publication and is allowed to edit any inputted information in the request form and directs the invented system whether to maintain the initiator of immediate request as anonymous. If the preview of the request is satisfactory, the requestor 106 selects to publish the request publicly in step 4.16, publishing it in step 4.18. Otherwise the requestor 106 goes back to step 4.14 to edit and preview the request until the requestor 106 is satisfied with the revision of the request. Once the request is published, the requestor 106, in step 4.20, then either shares the request privately with an intermediary 104 in step 4.22, or shares the request publicly with the givers 114-120 in step 4.24.

Once the system server 102 in step 4.26 determines that givers 114-120 have funded the request, the requestor 106 receives notification of the successful funding of the request in step 4.28. The product or products requested are shipped to the requestor 106 by the partner shopping site 110, and the requestor 106 receives the product or products in step 4.30. In step 4.32 the requestor 106 may optionally send either an anonymous or a self-identifying gratitude notification to the givers 114-120 that participated in funding the request. The gratitude notification may include photographs or a video of the received product or products in use. In step 4.34 the requestor 106 may choose to share a gratitude notification on the social network 108, and in step 4.36 the requestor 106 continues on to other tasks.

If the system server 102 in step 4.26 determines that funding was not successful, for example if a predetermined amount of time has passed since the initial request was made and the funding goal was not reached, the system server 102 continues onto other tasks to step 4.36.

Referring now generally to the Figures and particularly to FIG. 5, FIG. 5 is a flow chart depicting possible actions of the intermediary 104 within a possible scenario of the anonymous gifting processes wherein the intermediary 104 receives a request from a requestor 106 for a specific product or products, and shares the gift request with a plurality of givers 114-120, another intermediary 104, both, or neither.

In step 5.02 the intermediary 104 receives a request containing a uniquely identified product or set of products, and in step 5.04, the intermediary 104 signs up or logs into the system server 102 using a third social account of an established third party identity service. Once logged in, in step 5.06, the intermediary 104 may add information about the product request, for example noting one or more characteristics or qualities of the requestor 106 without identifying the requestor 106.

In step 5.08 the intermediary 104 may optionally share the request with a plurality of givers 114-120, and in step 5.10 decides if action by another intermediary 104 is desired. If action by another intermediary 104 is desired the original intermediary 104 shares the request with another intermediary 104 in step 5.12. Then, in step 5.14 the intermediary 104 may share the request on a social network server 108, and in step 5.16 the intermediary 104 continues to other tasks.

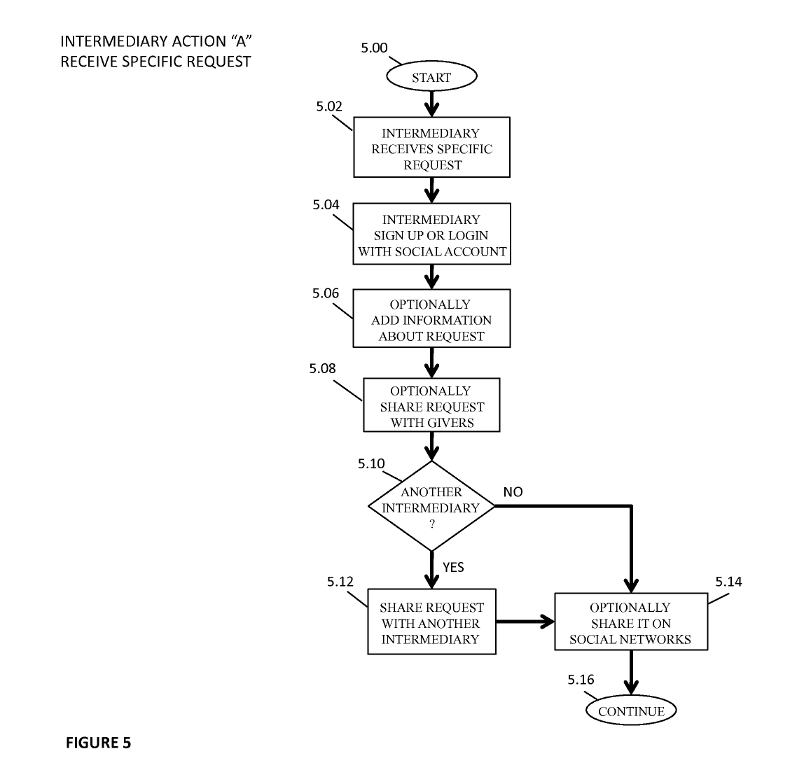

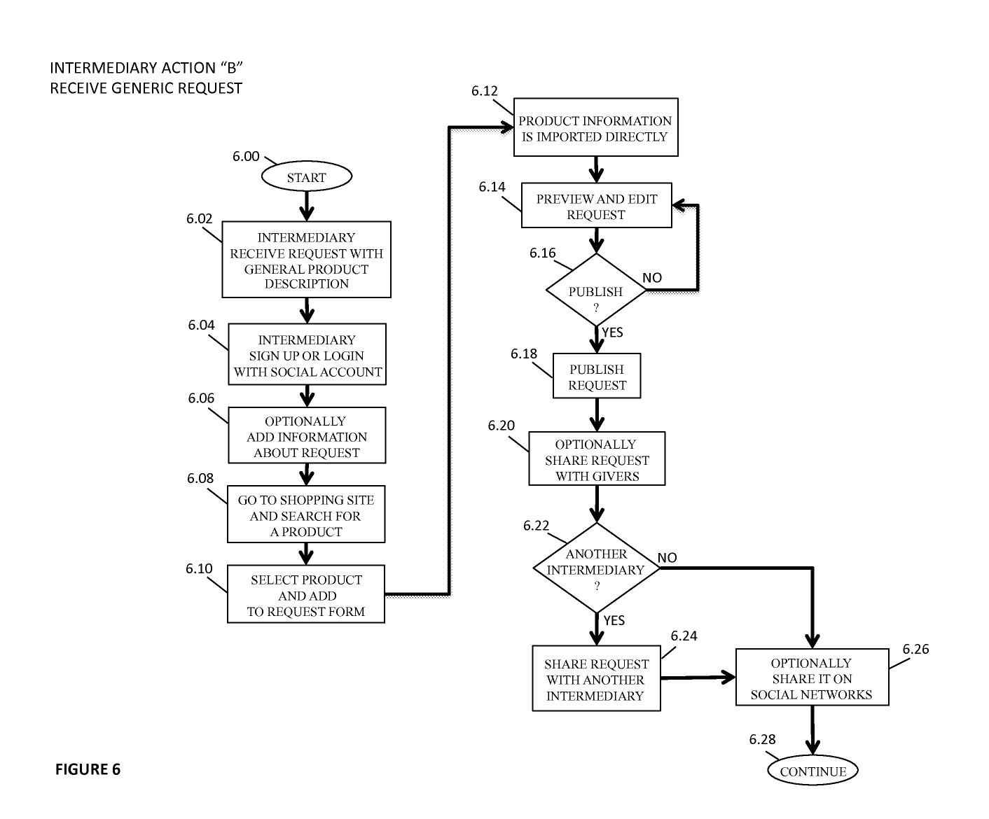

Referring now generally to the Figures and particularly to FIG. 6, FIG. 6 is a flow chart depicting possible actions of the intermediary 104 within a possible scenario of the anonymous gifting processes wherein the intermediary 104 receives a request from a requestor 106 for a generic product or products, selects specific products matching the requestor's 106 descriptions and shares the gift request with a plurality of givers 114-120, another intermediary 104, both, or neither.

In step 6.02 the intermediary 104 receives a request containing a general description of a product or set of products, and in step 6.04, the intermediary 104 signs up or logs into the system server 102 using a third social account of an established third party identity service. Once logged in, in step 6.06, the intermediary 104 may add information about the product request, for example noting one or more characteristics or qualities of the requestor 106 without identifying the requestor 106.

In step 6.08 the intermediary 104 is directed to the partner shopping site 110, where the intermediary searches for a product or set of products matching the general description the requestor 106 included in the request. In step 6.10 the intermediary 104 selects the desired product or products and adds identifying information about each desired product to the request form, in step 6.12 product details will be imported directly by the server system 102 to the request form. The invented system may in step 6.10 optionally and additionally automatically import and include in the instant request information from a shopping website related to requested item.

In step 6.14 the intermediary 104 previews the complete request as intended for publication and is allowed to edit inputted information in the request form. If the preview of the request is satisfactory, the intermediary 104 selects to publish the request publicly in step 6.16, publishing it in step 6.18. Otherwise the intermediary 104 returns to step 6.14 to edit and preview the request until the intermediary 104 is satisfied with the revision of the request. Once the request is published, the intermediary 104 may optionally share the request with a plurality of givers 114-120 in step 6.20. Then in step 6.22 the intermediary 104 decides if action by another intermediary 104 is desired in step 6.20. If action by another intermediary 104 is desired the original intermediary 104 shares the request with another intermediary 104 in step 6.22. And in step 6.26 the intermediary 104 may share the request on a social network server 108, and finally in step 6.28 the intermediary 104 continues to other tasks.

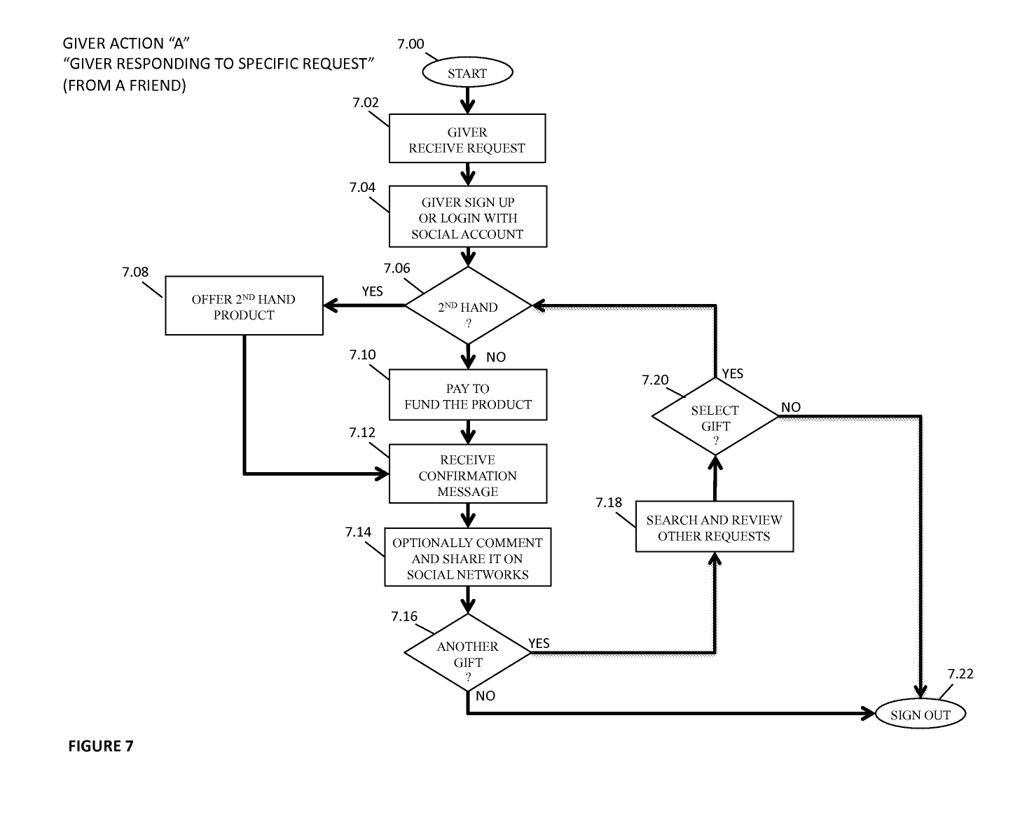

Referring now generally to the Figures and particularly to FIG. 7, FIG. 7 is a flow chart depicting possible actions of one of the givers 114-120 within a possible scenario of the anonymous gifting process wherein a giver 114 first receives a specific gift request and then logs into the system server 102 to fulfill the specific gift received.

In step 7.02 the giver 114 receives the request for a specified gift. This request could be received through a third party social networking service 108. In step 7.04 the giver 114 signs up or logs into the system server 102 using a second social account of an established third party identity service (hereinafter, “second social account” 108). Once logged-in, the giver 114 reviews the gift request, if it is indicated on the request that a previously used product or products are acceptable, and the giver 114 has access used versions of the requested products the giver 114 may choose to offer these products to fulfill the gift request in step 7.06, submitting the offer in step 7.08 and additionally and optionally inputting product photo and description to the request in step 7.09. Otherwise the giver 114 continues to step 7.10 and pays to fund any fraction of the gift request.

Once the giver 114 has completed the offer or payment a confirmation message will be received in step 7.12. Then in step 7.14 the giver 114 may optionally comment and share the confirmation message on the social network server 108.

In step 7.16 the giver decides whether or not to browse other gift requests that have been published on the system server 102, if not the giver 114 may optionally share the initial gift request by means of the social network server 108, then the giver continues to other tasks in step 7.24.

If the giver 114 does choose to continue to browse requests the giver 114 does so in step 7.18. If an appealing request is found and selected by the giver 114 in step 7.20 the giver 114 continues to step 7.06 to fulfill that request. If an appealing request is not found by the giver 114 in step 7.20, the giver 114 continues to other tasks in step 7.22.

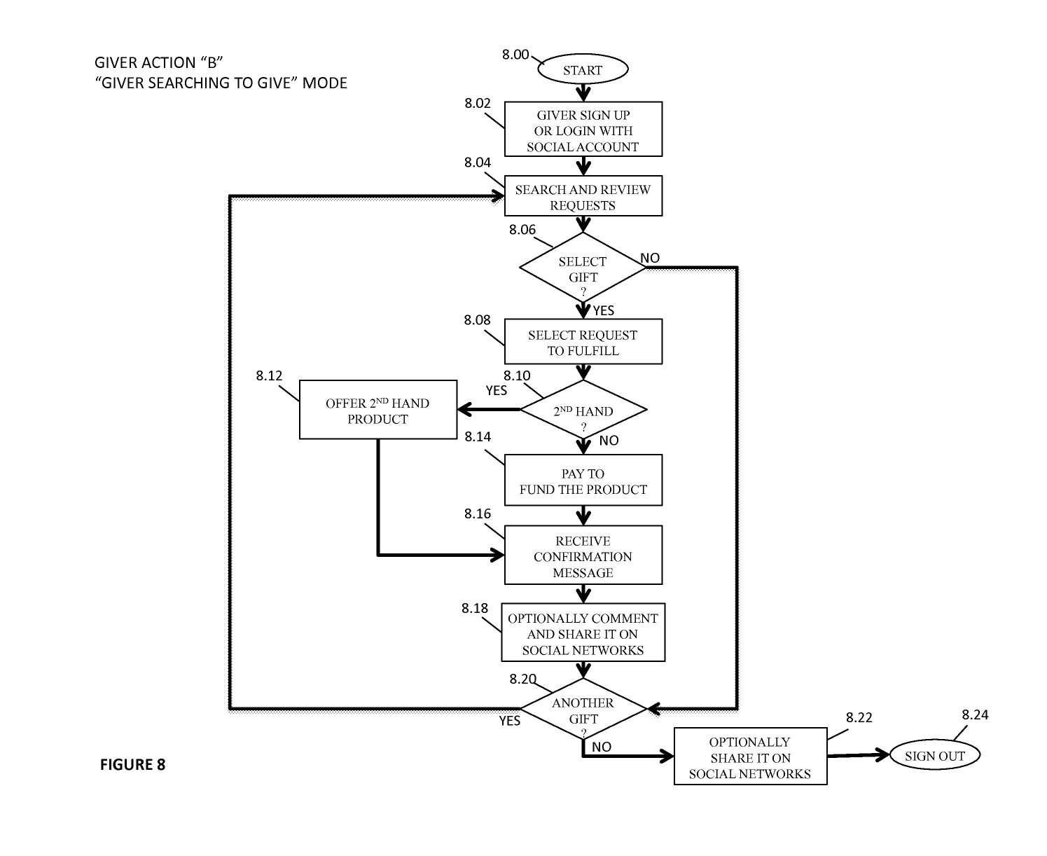

Referring now generally to the Figures and particularly to FIG. 8, FIG. 8 is a flow chart depicting possible actions of a giver 114 within a possible scenario of the anonymous gifting process wherein the giver 114 first logs into the system server 102 and then searches for and reviews one or more available requests to find and select an appealing request to fulfill.

In step 8.02 the giver 114 signs up or logs into the system server 102 using the second social account of the social network server 108. Next in step 8.04, the giver 114 searches and reviews gift requests that have been published to the system server 102. If a request is selected by the giver in step 8.06, the giver 114 continues on to step 8.08 to review that particular request. If it is indicated on the request selected in step 8.06 that a previously used product or products are acceptable, and the giver 114 has access to used, after-market or pre-owned versions of the requested products. The giver 114 may choose to offer one of these other-than-new products to fulfill the gift request in step 8.10, submitting the offer in step 8.12. Otherwise the giver 114 continues to step 8.14 and pays to fund any fraction of the gift request.

Once the selected gift is fulfilled, in step 8.16 the giver 114 receives a confirmation message. In step 8.14 the giver 114 may optionally add comments and share the confirmation message by means of the social network server 108.

In step 8.20 the giver 114 decides if continuing to review other requests is desirable. If it is desirable the giver 114 continues on to step 8.04 to search and review one or more other requests. If the giver does not wish to review additional requests, the giver may optionally share the original gift request by means of the social system server 102. And in step 8.24 the giver 114 continues on to other tasks.

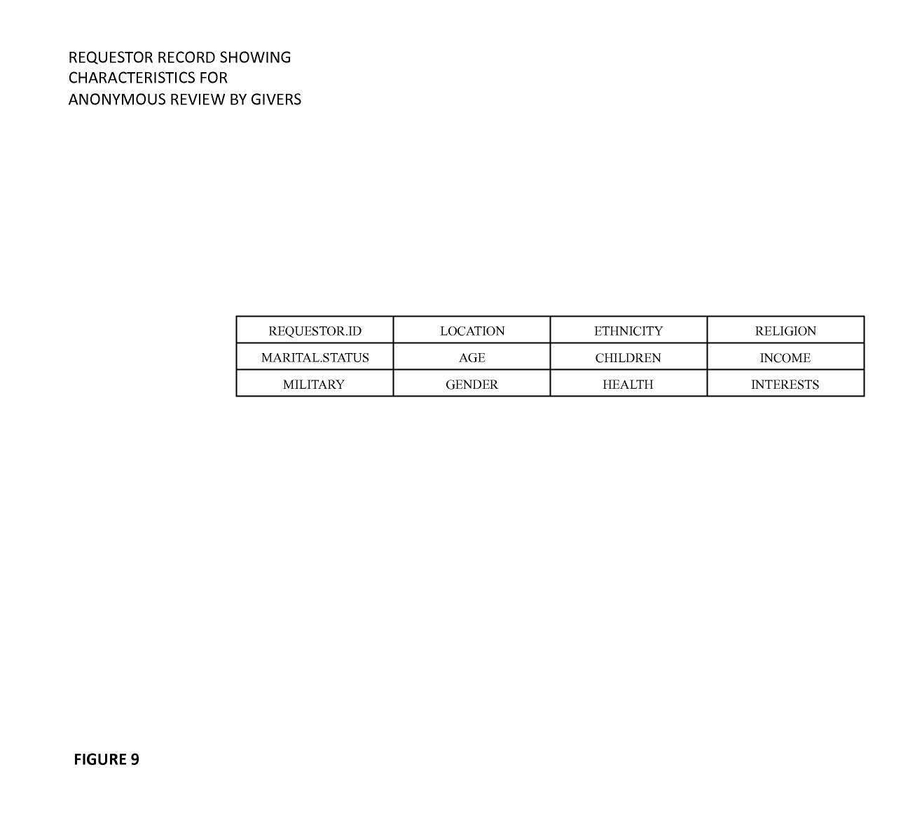

Referring now generally to the Figures and particularly to FIG. 9, FIG. 9 is a block diagram depicting requestor 106 characteristics that can be used within a possible scenario of the anonymous gifting process by givers 114-120 for searching and finding an appealing request to fund.

When requestor 114 signs up with system server 102 the requestor 106 may provide additional information, for example, but not limited to: location, ethnicity, religious affiliation, marital status, age, information about children and income.

Referring now generally to the Figures and particularly to FIG. 10 through 14I, FIGS. 10 through 14I disclose an alternate preferred embodiments wherein an alternate preferred embodiment of the invented method is presented. FIG. 10 is a software flowchart that presents optional aspects of the invented method of the requestor 106, under the direction of a human requester, interacting with the network 100, the system server 102, one or more social networks 108, and one or more intermediary systems 104. In step 10.02 the request 106 generates and sends a requestor profile descriptor message PROF.MSG to the system server 102 that enables the system server 102 to generate a requestor profile account record RP.ACCT.REC. The requestor profile descriptor message PROF.MSG preferably includes, as shown in FIG. 14A, an exemplary first requestor identifier REQ.ID, a requestor name REQ.NAME of an identified human requestor or other entity, a postal shipping address SHIP.ADDR, profile data PROF.DATA that is approved for public posting by the system server 102, and a private requestor information REQR.DATA that is not authorized for public disclosure.

In a following message the requestor 106 initiates an alternate gift request message A.REQ.MSG in step 10.04 and in step 10.06 optionally populates the alternate gift request message A.REQ.MSG, as shown in FIG. 14C, with a product purchasing hyperlink PUR.URL to a webpage at which a desired product may be purchased, a product identifier PRODUCT.ID of the desired product, a generic product description PRODUCT.DATA of the desired product, requestor posting information POST.DATA that is authorized by the requestor for public posting and dissemination, and product price information PRODUCT.PRICE. The product purchasing hyperlink PUR.URL may be copied from an ecommerce webpage published by a shopping partner 110, e.g., AMAZON.COM™ ecommerce website or the EBAY.COM™ ecommerce website. It is understood that the product purchasing hyperlink PUR.URL is a vendor identifier of an operator of the partner shopping site 110 or other ecommerce vendor, e.g., the AMAZON™ ecommerce website vendor and publisher of amazon.com or EBAY™ ecommerce auction website publisher of ebay.com. In step 10.08 the requestor 106 sends the alternate gift request message A.REQ.MSG to the server 10.08 and receives a posting message POST.MSG in step 10.10. The posting message POST.MSG preferably includes a gift request webpage address GIFT.URL of a website published by the system server 102 wherein information related to the gift request of the alternate gift request message A.REQ.MSG sent in step 10.08 is posted and at which the requested product may be selected for purchase.

In step 10.12 the request 106, under the direction of the human requestor, generates an intermediary request message IN.MSG and sends the intermediary request message IN.MSG to one or more intermediary systems 104, social networks 108, and/or giver systems 114-120. When the human requestor determines that a receipt of the requested product has occurred, the human requestor may optionally direct the request 106 to send a message expressing appreciation to the system server 102 and intended for forwarding to the giving person or entity. The requestor 106 proceeds from either step 10.16 or step 10.18 to step 10.20 and to perform alternate computational operations.

Referring now generally to the Figures and particularly to FIG. 11, FIG. 11 is a software flowchart that presents optional aspects of the invented method of the system server 102, under the direction of the invented system software, interacting with the network 100, requestor 106, one or more social networks 108, the intermediary systems 104, the partner shopping sites 110, the payment processor system 112, and the givers 114-120. In step 11.02 the system server 102 receives the requestor profile descriptor message PROF.MSG sent by the requestor in step 10.02. In step 11.04 server 102 generates a requestor profile account record RP.ACCT.REC and populates the newly generated requestor profile account record RP.ACCT.REC with data provided in the requestor profile descriptor message PROF.MSG. The system server 102 in step 11.06 receives the alternate gift request message A.REQ.MSG sent by the requestor 106 via the network 100 in step 10.08. The system server 102 thereupon generates an exemplary first posting record POST.REC.001 in step 11.07 and populates the newly created first posting record POST.REC.001 with the information provided in the alternate gift request message A.REQ.MSG and is stored in the requestor profile account record RP.ACCT.REC that is associated with the same requestor identifier REQ.ID that is included in the alternate gift request message A.REQ.MSG. It is understood that the requestor profile account record RP.ACCT.REC preferably includes each posting record POST.REC.001-POST.REC.N that lists a same requestor identifier REQ.ID as being associated with a same requestor.

The system server 102 then publishes a gift request webpage having a universal resource locator expressed as the gift request webpage address GIFT.URL in step 11.08. The system server 102 may optionally or additionally post some or all of the profile data PROF.DATA of the requestor profile account record RP.ACCT.REC and/or some or all of the requestor post information POST.DATA associated with the alternate gift request message A.REQ.MSG at the gift request webpage. The server forms and sends a posting message POST.MSG to the requestor 106 in step 11.10.

When the system server 102 detects receipt of an exemplary first gift message A.GIFT.MSG in step 11.12 that approves purchase of the product identified in the alternate gift request message A.REQ.MSG and provides sufficient financial account information FIN.DATA to fund the intended product purchase. In step 11.13 the server attempts to withdraw and receive the funds promised in the first gift message A.GIFT.MSG. When the promised funds are cleared in step 11.13, the server proceeds on to step 11.14, wherein the system server 102 generates and sends a purchase message PUR.MSG to a partner shopping site 110 and executes a purchase by providing sufficient financial account information and permission S.FIN.DATA to execute the intended purchase. The system server 102 further in step 11.14 provides the first partner shopping site 110 with the postal shipping address POST.ADDR of the requestor profile account record RP.ACCT.REC to direct and enable a shipment of the desired virtual product to the requestor and/or the requestor system address REQ.ADDR.

In step 11.16 the system server 102 optionally sends a notification message of the product purchase to the requestor network address REQ.ADDR in step 11.16. The system server 102 proceeds from either step 11.12 or step 11.16 to step 11.18 and to perform alternate computational operations.

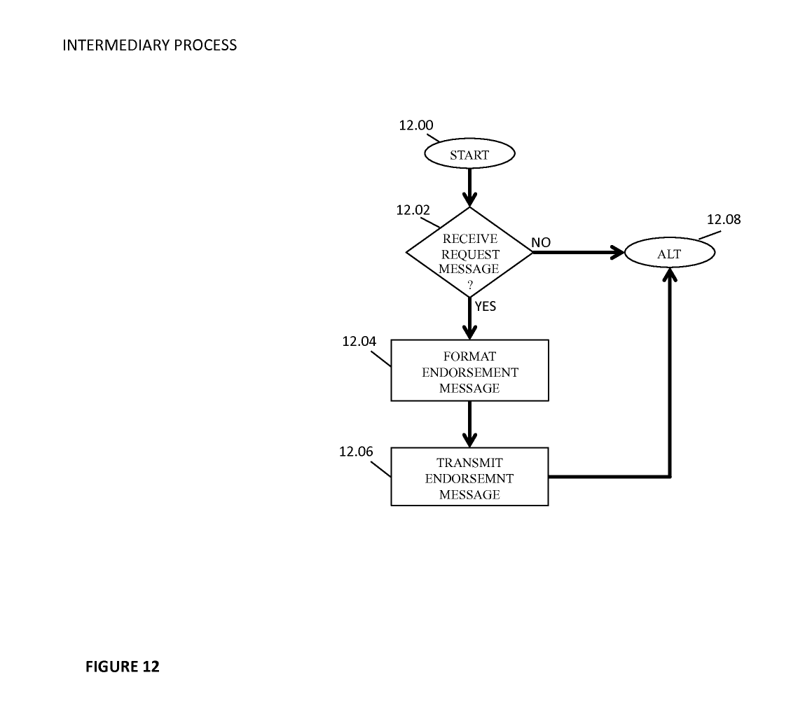

Referring now generally to the Figures and particularly to FIG. 12, is a software flowchart that presents optional aspects of the invented method of the intermediary 104, under the direction of an intermediary human, interacting with the network 100, requestor 106, one or more social networks 108, other intermediary systems 104, and one or more giver systems 114-120.

When the intermediary 104 detects receipt of an intermediary message IN.MSG of FIG. 12F in step 12.02 from the requestor 106, or alternatively from the system server 102, another intermediary 104, or a social network 108, the intermediary 104 proceeds on to step 11.04 and to format an endorsement message EN.MSG of FIG. 12G in step 12.04 and transmits the endorsement message EN.MSG via the network 100 in step 12.08. The intermediary 104 proceeds from either step 12.06 or step 12.02 to step 12.08 and to perform alternate computational operations.

Referring now generally to the Figures and particularly to FIG. 13, FIG. 13 is a software flowchart that presents optional aspects of the invented method of the exemplary first giver 114, under the direction of a human giver, interacting with the network 100, the system server 102, one or more social networks 108, and one or more intermediary systems 104. The first giver 114 launches a web browser in step 13.02 and optionally visits a gift request website published by the system server 102. Alternatively, the first giver 114 may detect receipt of the endorsement message EN.MSG as sent in step 12.06 from the intermediary 104. The first giver 114 may be directed by the human giver to proceed from either step 13.04 or step 13.06 to step 13.08 and TO render the webpage addressable at the gift webpage address GIFT.URL. The human giver may then direct the first giver 114 to offer to fund purchase of the requested product in step 13.10 and provide the necessary financial data FIN.DATA sufficient to effect the purchase in step 13.12. The first giver may proceed from steps 13.08, 13.10 and 13.12 to step 13.14 and to perform alternate computational operations.

Referring now generally to the Figures and particularly to FIG. 14A, FIG. 14A is a block diagram of an exemplary first requestor profile descriptor message PROF.MSG. The first requestor profile descriptor message PROF.MSG specifies the server network address SRV.ADDR as the destination address and the requestor network address REQ.ADDR as the origination address. The first requestor profile descriptor message PROF.MSG includes a profile payload PAY.PROF that includes a requestor identifier REQ.ID and may further include (a.) a postal shipping address SHIP.ADDR, (b.) a profile information PROF.DATA that is authorized by the requestor for public disclosure, and/or (c.) requestor information REQR.DATA that is not authorized by the requestor for public disclosure.

Referring now generally to the Figures and particularly to FIG. 14B, FIG. 14B is a block diagram of an exemplary first profile account record RP.ACCT.REC. The exemplary first profile account record RP.ACCT.REC includes the exemplary first requestor identifier REQ.ID and the exemplary profile payload PAY.PROF of received by the system server 102 in step 11.02. The first profile account record RP.ACCT.REC preferably includes one or more posting records POST.REC.001-POST.REC.N that are each associated with the first requestor identifier REQ.ID.

Referring now generally to the Figures and particularly to FIG. 14C, FIG. 14C is a block diagram of an exemplary first alternate gift request message A.REQ.MSG. The first alternate gift request message A.REQ.MSG specifies the server network address SERV.ADDR as the destination address and the requestor network address REQ.ADDR as the origination address. The first alternate gift request message A.REQ.MSG preferably includes as a request payload PAY.REQ the first requestor identifier REQ.ID and optionally the purchasing webpage address PUR.URL, a product identifier of the requested product PRODUCT.ID, a product information PRODUCT.DATA related to the requested product, posting information POST.DATA authorized for public disclosure in association with the purchasing webpage address PUR.URL, and/or product pricing information PRODUCT.PRICE.

Referring now generally to the Figures and particularly to FIG. 14D, FIG. 14D is a block diagram of an exemplary first posting record POST.REC.001. The first posting record POST.REC.001 includes a unique first posting record identifier POST.REC.ID, the first requestor identifier REQ.ID and optionally the purchasing webpage address PUR.URL, the product identifier PRODUCT.ID, the product information PRODUCT.DATA, the posting information POST.DATA, and/or the product pricing information PRODUCT.PRICE.

Referring now generally to the Figures and particularly to FIG. 14E, FIG. 14E is a block diagram of a first exemplary first posting message POST.MSG. The first posting message POST.MSG specifies the server network address SRV.ADDR as the origination address. The first posting message POST.MSG preferably includes the gift request webpage address GIFT.URL, the first posting record POST.REC.001, the authorized profile data PROF.DATA associated with the first requestor identifier REQ.ID, the product identifier PRODUCT.ID, the product information PRODUCT.DATA, the authorized posting information POST.DATA, the product pricing information PRODUCT.PRICE.

Referring now generally to the Figures and particularly to FIG. 14F, FIG. 14 F is a block diagram of an exemplary first intermediate message IN.MSG. The first intermediate message IN.MSG specifies the first network address of the intermediary 114 as the destination address and the requestor system network address REQ.ADDR as the origination address. It is noted that alternative or additional intermediate messages IN.MSG may include a same or similar intermediate message payload PAY.IN and be addressed to one or more alternate intermediary systems 104, one or more giver systems 114-120, and/or one or more social networks 108. It is further noted that the intermediate payload PAY.IN preferably includes no information that discloses an identity of a requestor 106 or requesting human. The first intermediate message IN.MSG preferably includes the gift request webpage address GIFT.URL, the first posting record identifier POST.REC.001, the profile data PROF.DATA associated with the first requestor identifier, the product identifier PRODUCT.ID, the product information PRODUCT.DATA, the authorized posting information POST.DATA, the authorized profile information PROF.DATA, and the product pricing information PRODUCT.PRICE.

In an alternate preferred embodiment of the method of FIGS. 10 through 14I, the requestor name REQ.NAME may optionally be added to the first intermediate message IN.MSG in step 10.12 to publicly disclose the requesting party's identity.

Referring now generally to the Figures and particularly to FIG. 14G, FIG. 14G is a block diagram of an exemplary first endorsement message EN.MSG. The endorsement message EN.MSG specifies the first network address of the intermediary 114 as the origination address and the addresses of one or more alternate intermediary systems 104, one or more giver systems 114-120, and/or one or more social networks 108 as the destination address. An exemplary network address GVR.ADDR of the first giver 114 is provided in FIG. 14G as an example and not as limiting to potential recipients. It is further noted that an endorsement message payload PAY.EN preferably includes no information that discloses an identity of a requestor 106 or the requesting human.

The first endorsement message EN.MSG preferably includes the gift request webpage address GIFT.URL, the first posting record identifier POST.REC.001, the profile data PROF.DATA associated with the first requestor identifier, the product identifier PRODUCT.ID, the product information PRODUCT.DATA, the authorized posting information POST.DATA, the authorized profile information PROF.DATA, and the product pricing information PRODUCT.PRICE.

In an alternate preferred embodiment of the method of FIGS. 10 through 14I, the requestor name REQ.NAME may optionally be added to the first endorsement message EN.MSG in step 12.04 to publicly disclose the requesting party's identity.

Referring now generally to the Figures and particularly to FIG. 14H, FIG. 14H is a block diagram of an exemplary first alternate gift message A.GIFT.MSG. The first alternate gift message A.GIFT.MSG specifies the first network address GVR.ADDR of the first giver 114 as the origination address and the addresses of one or more alternate intermediary systems 104, one or more giver systems 114-120, and/or one or more social networks 108 as the destination address. An exemplary network address GVR.ADDR of the first giver 114 is provided in FIG. 14G as an example and not as limiting to potential respondents to the request for gifting of FIG. 10.

The first alternate gift message A.GIFT.MSG preferably includes the first posting record identifier POST.REC.001, the product identifier PRODUCT.ID, and a giver financial account information and permission FIN.DATA sufficient to fund a purchase of the product indicated by the first posting record identifier POST.REC.001 and/or the product identifier PRODUCT.ID,

Referring now generally to the Figures and particularly to FIG. 14I, FIG. 14I is a block diagram of an exemplary first purchase message PUR.MSG. The first purchase message PUR.MSG specifies the server network address SRV.ADDR as the origination address and an ecommerce network address ECOM.ADDR of the shopping partner site 110 as the destination address. The first purchasing message PUR.MSG includes the requestor name REQ.NAME this is a named intended recipient of the requested product, a server financial account data and permission S.FIN.DARA sufficient to execute a purchase of the product associated with the included product identifier PRODUCT.ID, a postal shipping address SHIP.ADDR to which a physical good may be shipped, the requestor system network address REQ.ADDR to which documentation related to a virtual good may be sent by electronic messaging.

The foregoing disclosures and statements are illustrative only of the Present Invention, and are not intended to limit or define the scope of the Present Invention. The above description is intended to be illustrative, and not restrictive. Although the examples given include many specificities, they are intended as illustrative of only certain possible configurations or aspects of the Present Invention. The examples given should only be interpreted as illustrations of some of the preferred configurations or aspects of the Present Invention, and the full scope of the Present Invention should be determined by the appended claims and their legal equivalents. Those skilled in the art will appreciate that various adaptations and modifications of the just-described preferred embodiments could be configured without departing from the scope and spirit of the Present Invention. Therefore, it is to be understood that the Present Invention may be practiced other than as specifically described herein. The scope of the present invention as disclosed and claimed should, therefore, be determined with reference to the knowledge of one skilled in the art and in light of the disclosures presented above.

I claim:

1. A computer-implemented method comprising:
a. receiving an electronic notice of a gift request from a first party for a good or a service;
b. generating an endorsed request, the endorsed request identifying the good or service and an endorsing party while providing anonymity to the first party regarding the endorsed request;
c. publishing the endorsed request within an electronics communications network;
d. enabling authorization of a fulfillment of the endorsed request by a third party, whereby delivery of the good or service is enabled while maintaining the first party as anonymous to the third party.

2. The computer-implemented method of claim 1, wherein the first party is identified to the endorsing party.

3. The computer-implemented method of claim 1, wherein the first party is anonymous to the endorsing party.

4. The computer-implemented method of claim 1, wherein an affiliation of the first party is known by the endorsing party.

5. The computer-implemented method of claim 1, wherein the endorsing party is anonymous to the first party.

6. The computer-implemented method of claim 1, wherein the third party is identified to the first party.

7. The computer-implemented method of claim 1, wherein the endorsing party is identified to the first party.

8. The computer-implemented method of claim 1, wherein the gift request is posted at a website.

9. The computer-implemented method of claim 1, wherein the gift request is published within an electronically mediated social network.

10. The computer-implemented method of claim 1, wherein the gift request is published by electronic mail.

11. The computer-implemented method of claim 1, wherein the endorsed request is posted at a website.

12. The computer-implemented method of claim 1, wherein the endorsed request is published within an electronically mediated social network.

13. The computer-implemented method of claim 1, wherein the endorsed request is published by electronic mail.

14. The computer-implemented method of claim 1, wherein the gift request is published in association with a vendor identifier.

15. The computer-implemented method of claim 1, wherein the gift request is published within an electronic message and in association with a hyperlink to a purchase placement network address.

16. The computer-implemented method of claim 1, wherein the gift request is published within a website and in association with a hyperlink to a purchase placement network address.

17. The computer-implemented method of claim 1, wherein the gift request is published within an electronically mediated social network and in association with a hyperlink to a purchase placement network address.

18. The computer-implemented method of claim 1, wherein the first party is enabled to transmit an electronic message to the third party.

19. A system comprising:
a. means to receive an electronic notice of a gift request from a first party for a good or service;
b. means to generate an endorsed request, the endorsed request identifying the good or service and an endorsing party while providing anonymity to the first party regarding the endorsed request;
c. means to publish the endorsed request within an electronics communications network; and
d. means to enable authorization of a fulfillment of the endorsed request by a third party, whereby delivery of the good or service is enabled while maintaining the first party as anonymous to the third party.

20. In an electronics communications network, computer-implemented method comprising:
a. Publishing a request of a first party for a gift as a request message, the request message specifying an endorsing party, a requested gift, a hyperlink to fulfillment service, but not the identity of the first party;
b. Providing the fulfillment service with a shipping address for shipment of the requested gift;
c. Receiving payment for the requested gift from a third party; and
d. Shipping the requested gift to the shipping address.
